(19) United States
(12) Patent Application Publication
(10) Pub. No.: US 2002/0035990 A1
(43) Pub. Date: Mar. 28, 2002

(54) Evaporative fuel treating system

(76) Inventors: Shigeru Yoshida, Obu-shi (JP); Kazumi Haruta, Obu-shi (JP); Daisuke Ito, Obu-shi (JP)

Correspondence Address: BAKER & BOTTS, 30 ROCKEFELLER PLAZA, NEW YORK, NY, 10112

(21) Appl. No.: 09/998,970

(22) Filed: Oct. 31, 2001

(30) Foreign Application Priority Data
Jun. 11, 2000 (JP) 2000-376698

(51) Int. Cl. F02M 33/02; G01M 19/00

(52) U.S. Cl. 123/520; 73/118.1

(57) ABSTRACT

An evaporative fuel treating system is free from the problem that the number of opportunities for fault detection is reduced by the restriction on the timing for diagnosis, and capable of performing a fault diagnosis on the whole purge passage from a fuel tank to an intake pipe. After an atmospheric air inlet valve of a canister has been closed, the operation of a purge pump is stopped when the negative pressure in the fuel tank has reached a predetermined value as a result of the operation of the purge pump. At the same time, or immediately after the purge pump has stopped, a flow control valve provided on or near the intake pipe is closed. After a predetermined period of time has elapsed, a change in pressure in the fuel tank is detected, thereby inspecting the purge passage for a leakage. Therefore, a fault diagnosis can be performed irrespective of the engine operating conditions. Accordingly, there is no reduction in the number of opportunities for fault detection. In addition, a fault diagnosis can be made on the whole purge passage.

### BACKGROUND OF THE INVENTION

The present invention relates to an evaporative fuel treating system for use in an automobile equipped with an engine having an intake pipe negative pressure of 20 kPa or less.

Japanese Patent Application Unexamined Publication (KOKAI) No. Hei 11-30158 discloses a technique relating to an evaporative fuel treating system for use in an automobile equipped with an engine having a relatively small intake pipe negative pressure, e.g. a lean-burn engine, which uses a leaner mixture of fuel and air than the stoichiometric mixture or the economic mixture for the purpose of reducing fuel consumption to increase fuel economy. According to the above publication, evaporative fuel is sent to the intake pipe side by operating a purge pump (i.e. a pump for purging) comprising a fuel-driven or motor-driven rotary pump when purge execution conditions are satisfied, for example, when the engine is running under high-vehicle speed conditions with a wide throttle opening during operation other than deceleration, or when the engine is running at high speed with a wide throttle opening under conditions other than heavy load, or when the engine has been just started, or every predetermined period of time.

During the operation of the purge pump, a purge control valve is opened, and an atmospheric air hole formed in a canister is closed with a canister control valve. After a predetermined period of time has elapsed in this state, the pressure in the fuel tank is detected with an internal pressure sensor. When the pressure in the fuel tank detected with the sensor is higher than the set internal pressure, i.e. when the detected pressure is closer to the atmospheric pressure than the set pressure, the evaporative emission control system is diagnosed as having a fault, and an audio alarm device, e.g. a buzzer, or a visual alarm device, e.g. a lamp, is activated to inform the car's occupant of the fault.

### SUMMARY OF THE INVENTION

However, the above-described conventional system has disadvantages as follows. Engine operating conditions where a fault diagnosis can be performed are restricted to the following: when the engine is running under high-vehicle speed conditions with a wide throttle opening during operation other than deceleration; when the engine is running at high speed with a wide throttle opening under conditions other than heavy load; and so forth. Thus, the number of opportunities for fault detection is reduced by the restriction on the timing for diagnosis. Further, a fault diagnosis can be performed only on the section of the purge passage in which a negative pressure is produced, that is, the purge passage section upstream of the purge pump (i.e. the purge passage section extending from the fuel tank to the purge pump). In other words, a fault diagnosis cannot be made on the whole purge passage (from the fuel tank to the intake pipe). In addition, the rotary pump in the above-described conventional system needs to minimize the leakage loss at the periphery of a rotating member in order to ensure the desired performance. Accordingly, high accuracy is required for the components. This results in a costly system.

Under these circumstances, an object of the present invention is to propose a low-cost evaporative fuel treating system free from the problem that the number of opportunities for fault detection is reduced by the restriction on the timing for diagnosis, and capable of performing a fault diagnosis on the whole purge passage from the fuel tank to the intake pipe.

According to a first aspect of the present invention, there is provided an evaporative fuel treating system of the type wherein evaporative fuel adsorbed in a canister is forcedly desorbed and sent to an intake pipe. The system includes a purge pump provided in an intermediate part of a purge passage. The purge pump has check valves respectively provided for the suction side and the discharge side thereof. The system further includes a flow control valve provided on or near the intake pipe. After an atmospheric air inlet valve of the canister has been closed, the operation of the purge pump is stopped when the negative pressure in a fuel tank has reached a predetermined value as a result of the operation of the purge pump. At the same time, or immediately after the purge pump has stopped, the flow control valve provided on or near the intake pipe is closed. After a predetermined period of time has elapsed, a change in pressure in the fuel tank is detected, thereby inspecting the whole purge passage for a fault.

Preferably, the evaporative fuel treating system further includes a bypass passage connecting together a suction opening and a discharge opening of the purge pump.

The bypass passage may be provided in the purge pump.

Preferably, the bypass passage is provided with a restrictor.

According to a second aspect of the present invention, there is provided an evaporative fuel treating system including a purge passage for communication between an intake pipe of an engine and a fuel tank. A canister is provided in an intermediate part of the purge passage to temporarily adsorb evaporative fuel generated in the fuel tank. A purge pump is provided in a section of the purge passage that provides communication between the canister and the intake pipe. The purge pump is adapted to forcedly send evaporative fuel from the canister to the intake pipe. The purge pump has a variable-volume pump chamber communicated with a suction opening and a discharge opening of the purge pump through a first check valve and a second check valve, respectively. The first check valve and the second check valve are arranged to open only in a direction in which evaporative fuel moves from the suction opening toward the discharge opening. After an atmospheric air inlet valve of the canister has been closed, the operation of the purge pump is stopped when the negative pressure in the fuel tank has reached a predetermined value as a result of the operation of the purge pump. At the same time, or immediately after the purge pump has stopped, a flow control valve provided on or near the intake pipe is closed. After a predetermined period of time has elapsed, a change in pressure in the fuel tank is detected, thereby inspecting the whole purge passage for a fault.

Preferably, the evaporative fuel treating system further includes a bypass passage connecting together the suction opening and the discharge opening of the purge pump.

The bypass passage may be provided in the purge pump.

Preferably, the bypass passage is provided with a restrictor.

The present invention arranged as set forth in the appended claims provides the following advantageous effects.

The pressure in the fuel tank (i.e. the pressure in the purge passage section upstream of the purge pump) is detected, and the whole purge passage is closed. After a predetermined period of time has elapsed, a pressure drop is detected to make a diagnosis of leakage. Therefore, a fault diagnosis can be performed any time irrespective of the engine operating conditions. Accordingly, there is no reduction in the number of opportunities for fault detection. In addition, because the flow control valve is installed on or near the intake pipe, a fault diagnosis can be made on the whole purge passage from the fuel tank to the intake pipe. Because the purge pump has no rotary sliding member, the components are easy to produce and hence less costly.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a conceptual view of an evaporative fuel treating system according to a first embodiment of the present invention.

FIG. 2 is a vertical sectional view of a purge pump in the evaporative fuel treating system according to the first embodiment of the present invention.

FIG. 3 is a vertical sectional view of a purge pump in an evaporative fuel treating system according to a second embodiment of the present invention.

FIG. 4A is a vertical sectional view of a purge pump in an evaporative fuel treating system according to a third embodiment of the present invention.

FIG. 4B is a sectional view taken along the line A-A in FIG. 4A.

### DESCRIPTION OF THE PREFERRED EMBODIMENTS

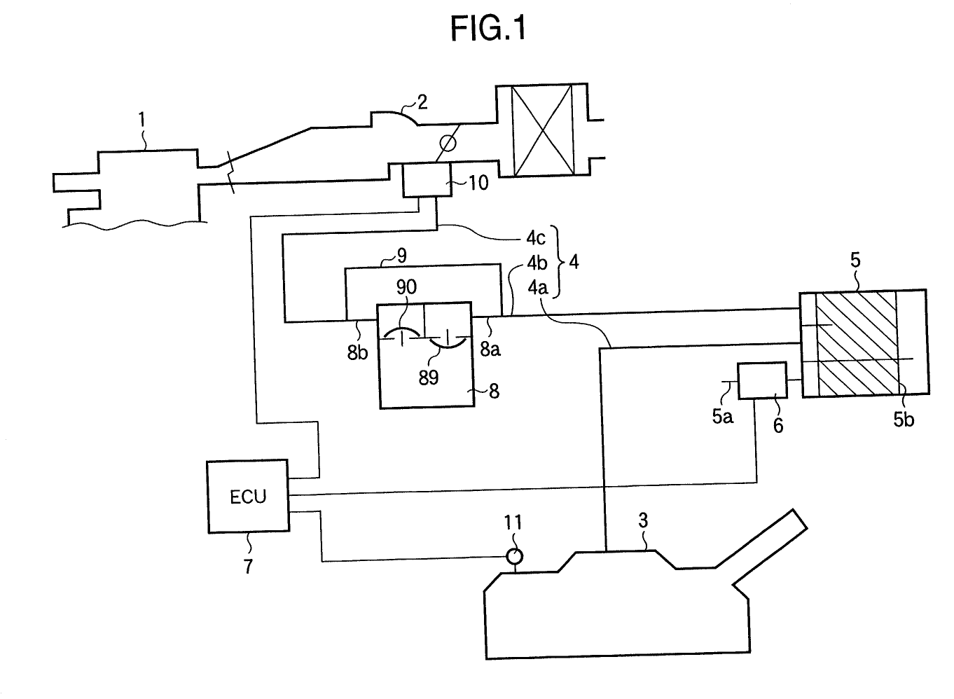

Preferred embodiments of the present invention will be described below with reference to the accompanying drawings. In FIG. 1, a purge passage 4 for passing evaporative fuel extends from an intake pipe 2 of an engine 1 to the top of a fuel tank 3. A canister 5 is provided in an intermediate part of the purge passage 4 to temporarily adsorb fuel evaporated in the fuel tank 3. An atmospheric air inlet valve 6 is provided in an atmospheric air passage 5a of the canister 5. The atmospheric air inlet valve 6 is opened or closed in response to a signal controlled by an ECU (Electronic Control Unit) 7. A purge pump 8 is provided on the downstream side (engine side) of the canister 5. The purge pump 8 is driven by either the engine 1 or an electric motor (not shown) to forcedly send evaporative fuel adsorbed in the canister 5 into the intake pipe 2.

A bypass passage 9 is formed to provide communication between a suction opening 8a and a discharge opening 8b of the purge pump 8. A restrictor (not shown) is provided in the bypass passage 9 to restrict the flow of evaporative fuel passing therethrough. A flow control valve 10 is provided at or near an opening of the purge passage 4 that is open into the intake pipe 2. The flow control valve 10 comprises an on-off valve that is duty-controlled by an electric signal from the ECU 7. A pressure sensor 11 is provided at the top of the fuel tank 3 to detect the pressure in the fuel tank 3. The pressure sensor 11 sends the detected signal to the ECU 7.

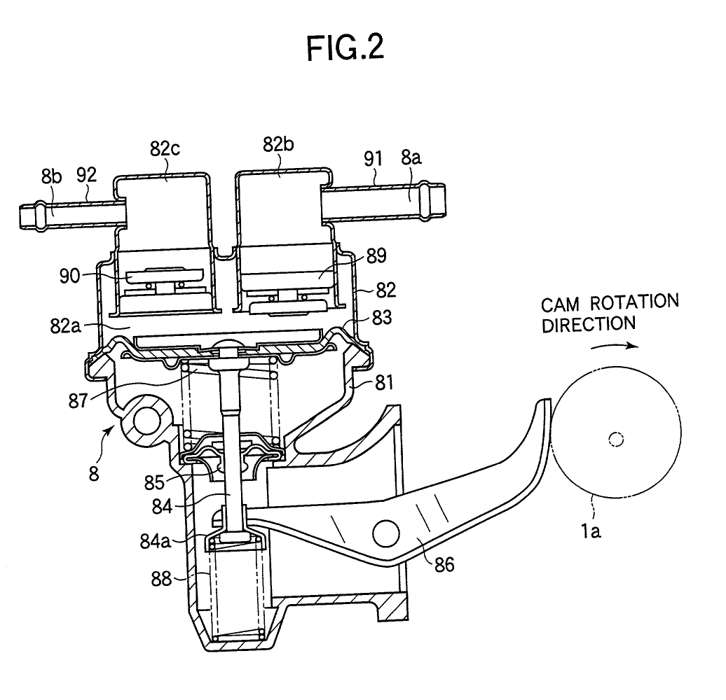

Next, the arrangement of the purge pump 8 will be described in detail with reference to FIG. 2. In FIG. 2, a diaphragm 83 is held between a pump housing 81 formed by casting of aluminum and a pump cover 82 formed from a steel plate by press forming. A diaphragm rod 84 is integrally secured to the diaphragm 83. The central portion of the diaphragm rod 84 is supported by a seal diaphragm 85. Thus, the diaphragm rod 84 is supported axially movably. The distal end portion (lower end portion as viewed in the figure) of the diaphragm rod 84 is retained to one end of a pump lever 86 through a retainer 84a brazed thereto. The outer end portion of the pump lever 86 is engaged with a cam shaft la of the engine 1. The central portion of the pump lever 86 is rotatably supported by the pump housing 81. The diaphragm 83 is pressed upwardly by a first spring 87 and a second spring 88. The diaphragm rod 84 is retained to the pump lever 86.

Meanwhile, a pump chamber 82a is formed between the pump cover 82 and the diaphragm 83. The pump chamber 82a communicates with a suction-side space 82b through a first check valve 89 and also communicates with a discharge-side space 82c through a second check valve 90. A suction pipe 91 is brazed to the wall of the suction-side space 82b to form a suction opening 8a. A discharge pipe 92 is brazed to the wall of the discharge-side space 82c to form a discharge opening 8b. The first and second check valves 89 and 90 are both arranged to open in a direction in which evaporative fuel moves from the suction opening 8a toward the discharge opening 8b and to close in the opposite direction. In the above-described arrangement, the volumetric capacity of the pump chamber 82a is variable to suck and discharge evaporative fuel. Therefore, there is no rotary sliding member, and the accuracy required for the components is not very high. Accordingly, the purge pump 8 can be produced at reduced costs.

Next, the operation of this embodiment will be described. In FIG. 1, when the temperature in the fuel tank 3 rises in a state where engine 1 is at rest, the fuel in the fuel tank 3 evaporates. The evaporative fuel passes through the purge passage 4 and is adsorbed by an adsorbent 5b in the canister 5, thereby being prevented from leaking to the outside. Next, when the engine 1 is operated, the flow control valve 10 is opened, and the purge pump 8 is driven. The evaporative fuel in the canister 5 is desorbed by the sucking force of the purge pump 8 and forcedly sent to the intake pipe 2, together with air flowing in from the atmospheric air inlet valve 6 that is open. The evaporative fuel is then burned in the engine 1. The flow control valve 10 is duty-controlled by a signal from the ECU 7 so as to supply the purge gas containing evaporative fuel at an optimum flow rate according to the load on the engine 1.

When the time to make a fault diagnosis on the purge passage 4 comes, first, the atmospheric air inlet valve 6 is closed. Consequently, the pressure in the purge passage sections 4a and 4b upstream of the purge pump 8 becomes negative owing to the sucking force of the purge pump 8, while the pressure in the downstream-side purge passage section 4c becomes positive. The pressure in the upstream-side purge passage sections 4a and 4b, that is, the pressure in the fuel tank 3, is detected with the pressure sensor 11. When the detected pressure has stabilized at a predetermined negative pressure (for example, when the rate of change of pressure within a predetermined period of time has become lower than a predetermined value), the drive of the purge pump 8 is stopped. At the same time, or immediately after the purge pump 8 has stopped, the flow control valve 10 is closed. At this time, because the first and second check valves 89 and 90 are closed, the pressure (positive) in the purge passage section 4c is not transmitted to the purge passage section 4b through the check valves 89 and 90. However, the positive pressure is transmitted to the purge passage section 4b through the bypass passage 9. As a result, the pressure in the whole purge passage 4 and the pressure in the fuel tank 3 equilibrate with each other at the same pressure (negative).

After a predetermined period of time has elapsed, the negative pressure is detected with the pressure sensor 11. When the negative pressure has become less than the value at the time of closing the flow control valve 10, that is, when the amount of change of the negative pressure toward the atmospheric pressure is more than a predetermined value, it is judged that there is a leakage in the purge passage 4. Further, the restrictor (not shown) provided in the bypass passage 9 makes it possible to minimize the amount of evaporative fuel flowing backward through the bypass passage 9 after it has been delivered by the purge pump 8. It should be noted that when the purge pump disclosed in Japanese Patent Application Unexamined Publication (KOKAI) No. Hei 11-30158 is used, the suction opening 8a and the discharge opening 8b are communicated with each other inside the purge pump when the operation of the pump is stopped. Therefore, it is not necessary to provide the bypass passage 9 particularly.

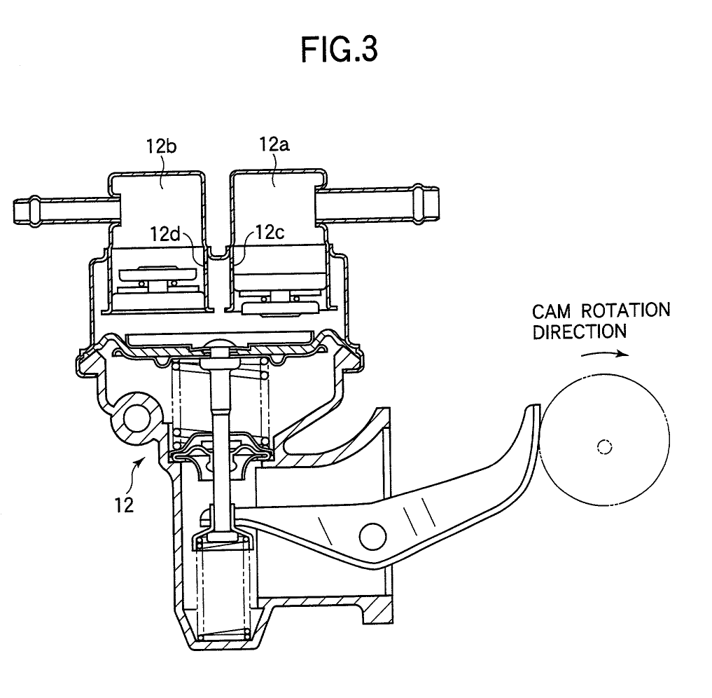

Next, a second embodiment of the present invention will be described. In FIG. 3, a suction-side space 12a and a discharge-side space 12b of a purge pump 12 are communicated with each other through restrictor holes 12c and 12d to form a bypass functioning as the bypass passage 9 in the first embodiment (FIG. 1). Accordingly, a passage bypassing the purge pump 12 need not be provided separately. Thus, the number of components required can be reduced. It should be noted that the other function and operation of the purge pump 12 are the same as in the first embodiment. Therefore, a description thereof is omitted.

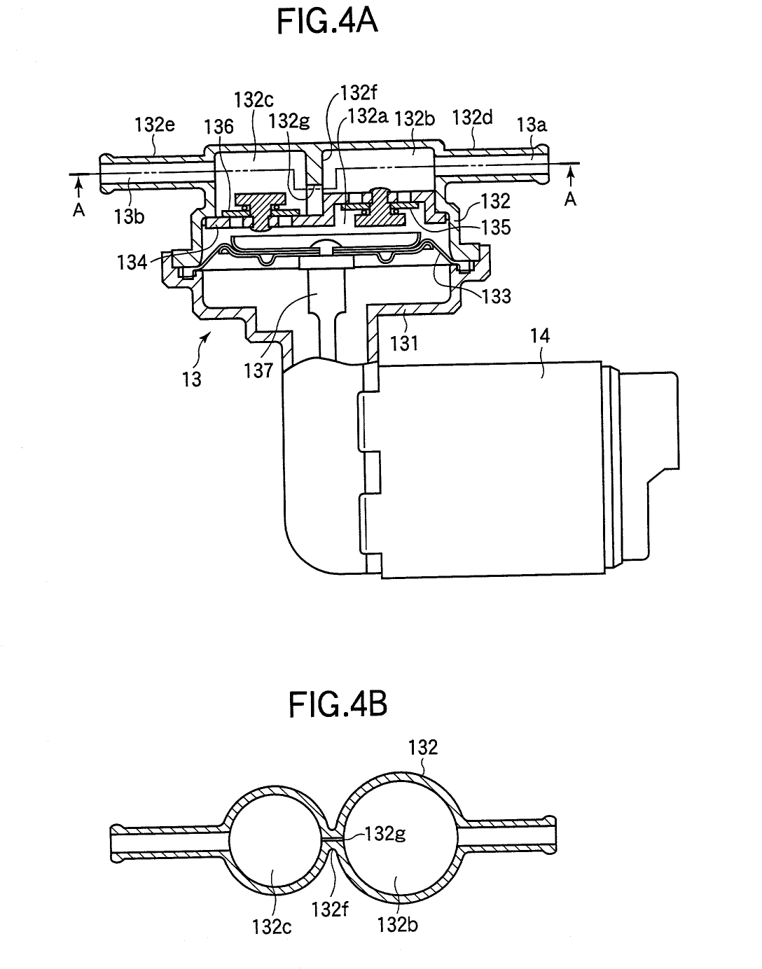

Next, a third embodiment of the present invention will be described. In FIGS. 4A and 4B, a diaphragm 133 is hermetically held between a pump housing 131 made of a synthetic resin material and a pump cover 132 similarly made of a synthetic resin material, and thermowelded at welds thereof. A valve body 134 is provided in the pump cover 132 and welded thereto integrally to form a valve chamber 132a, a suction-side space 132b and a discharge-side space 132c. The valve body 134 is provided with a first check valve 135 and a second check valve 136 so that the check valves 135 and 136 are opened by the flow of evaporative fuel from a suction opening 13a toward a discharge opening 13b. A suction pipe 132d is provided over the suction-side space 132b to form the suction opening 13a. A discharge pipe 132e is provided over the discharge-side space 132c to form the discharge opening 13b. A partition wall 132f divides the suction-side space 132b and the discharge-side space 132c from each other. A slit-shaped restrictor 132g is provided in the partition wall 132f to form a bypass passage for communication between the suction-side space 132b and the discharge-side space 132c.

A diaphragm rod 137 is integrally secured to the diaphragm 133. The distal end portion (not shown) of the diaphragm rod 137 is eccentrically and rotatably engaged with a motor shaft (not shown) of an electric motor 14 secured to the pump housing 131. The diaphragm rod 137 moves up and down in response to the rotation of the electric motor 14, causing the diaphragm 133 to move up and down. When the electric motor 14 is at rest, even if the first check valves 135 and 136 are closed, the pressure is transmitted between the suction opening 13a and the discharge opening 13b through the restrictor 132g. It should be noted that the operation of this embodiment is similar to that of the first embodiment. Therefore, a description thereof is omitted.

It should be noted that the present invention is not necessarily limited to the foregoing embodiments but can be modified in a variety of ways without departing from the gist of the present invention.

What is claimed is:

1. An evaporative fuel treating system of the type wherein evaporative fuel adsorbed in a canister is forcedly desorbed and sent to an intake pipe, said system comprising:
a purge pump provided in an intermediate part of a purge passage, said purge pump having check valves respectively provided for a suction side and a discharge side thereof; and
a flow control valve provided on or near said intake pipe;
wherein after an atmospheric air inlet valve of said canister has been closed, an operation of said purge pump is stopped when a negative pressure in a fuel tank has reached a predetermined value as a result of the operation of said purge pump, and at the same time, or immediately after said purge pump has stopped, said flow control valve is closed, and after a predetermined period of time has elapsed, a change in pressure in said fuel tank is detected, thereby inspecting a whole of said purge passage for a fault.

2. An evaporative fuel treating system according to claim 1, further comprising:
a bypass passage connecting together a suction opening and a discharge opening of said purge pump.

3. An evaporative fuel treating system according to claim 2, wherein said bypass passage is provided in said purge pump.

4. An evaporative fuel treating system according to claim 2 or 3, wherein said bypass passage is provided with a restrictor.

5. An evaporative fuel treating system comprising:
a purge passage for communication between an intake pipe of an engine and a fuel tank;
a canister provided in an intermediate part of said purge passage to temporarily adsorb evaporative fuel generated in said fuel tank; and
a purge pump provided in a section of said purge passage that provides communication between said canister and said intake pipe, said purge pump being adapted to forcedly send evaporative fuel from said canister to said intake pipe;
wherein said purge pump has a variable-volume pump chamber communicated with a suction opening and a discharge opening of said purge pump through a first check valve and a second check valve, respectively, said first check valve and said second check valve being arranged to open only in a direction in which evaporative fuel moves from said suction opening toward said discharge opening; and
wherein after an atmospheric air inlet valve of said canister has been closed, an operation of said purge pump is stopped when a negative pressure in said fuel tank has reached a predetermined value as a result of the operation of said purge pump, and at the same time, or immediately after said purge pump has stopped, a flow control valve provided on or near said intake pipe is closed, and after a predetermined period of time has elapsed, a change in pressure in said fuel tank is detected, thereby inspecting a whole of said purge passage for a fault.

6. An evaporative fuel treating system according to claim 5, further comprising:
a bypass passage connecting together the suction opening and the discharge opening of said purge pump.

7. An evaporative fuel treating system according to claim 6, wherein said bypass passage is provided in said purge pump.

8. An evaporative fuel treating system according to claim 6 or 7, wherein said bypass passage is provided with a restrictor.
